(19) United States
(12) Patent Application Publication
(10) Pub. No.: US 2018/0268318 A1
(43) Pub. Date: Sep. 20, 2018

(54) TRAINING CLASSIFICATION ALGORITHMS TO PREDICT END-USER BEHAVIOR BASED ON HISTORICAL CONVERSATION DATA

(71) Applicant: Adobe Systems Incorporated, San Jose, CA (US)

(72) Inventors: Satya Prateek Matam, Kukatpally (IN); Preetansh Goyal, Jabalpur (IN); Ashwin Rajendra Bhat, Mumbai (IN); Harsh Jhamtani, Kanpur (IN); Atanu Ranjan Sinha, Bangalore (IN); Kundan Krishna, Bangalore (IN)

(21) Appl. No.: 15/462,144

(22) Filed: Mar. 17, 2017

(51) Int. Cl. G06N 99/00; G06N 7/00

(52) U.S. Cl. CPC G06N 99/005; G06N 7/005

(57) ABSTRACT

This disclosure involves training classification algorithms to predict end-user behavior based on historical conversation data. For example, a computing system accesses training data with conversational and non-conversational data. The system derives decision points from a textual analysis of the conversational training data. The computing system fits a hidden Markov model having multiple hidden states to the non-conversational data. The computing system groups observations from the non-conversational data and the derived decision points into data segments. Each data segment includes a subset of the observations and the decision points associated with a hidden state. The computing system generates, from each data segment, a predictive model for the hidden state. Subsequently, input non-conversational data is matched to one of the hidden states. A predicted behavior for the entity is generated by applying the predictive model for that hidden state to both input conversational data and the input non-conversational data for the entity.

### TECHNICAL FIELD

This disclosure generally relates to artificial intelligence. More specifically, but not by way of limitation, this disclosure relates to generating models that simulate decision-making, where generating the models involves training classification algorithms to predict end-user behavior based on historical conversation data.

### BACKGROUND

Automated modeling systems are used for analyzing interactions with online services that provide digital forums in which end users may interact with online content (e.g., by purchasing products or services, commenting on products or services, etc.). Automated modeling systems use modeling algorithms that involve techniques such as logistic regression, neural networks, support vector machines, etc. These automated modeling algorithms are trained using training data, which can be generated by or otherwise indicate certain electronic interactions, transactions, or circumstances. This training data is analyzed by one or more computing devices of an automated modeling system. The training data is grouped into predictor variables that are provided as inputs to the automated modeling system. The automated modeling system uses this analysis to make predictions using data describing similar circumstances. For example, the automated modeling system uses the predictor variables to learn how to generate predictive outputs involving online transactions (or other circumstances) that are similar to the predictor variables from the training data.

Existing automated modeling systems use clickstream data and user profile data for analyzing and predicting the decisions made by users of online services. These modeling systems use past consumer behaviors to predict how consumers will behave with respect to future transactions. Past consumer behaviors are modeled using clickstream data (e.g., data describing which interface features of an online service were “clicked” or otherwise accessed during a session). For example, these automated modeling systems are used for estimating the value of consumer based on available clickstream data for the consumer. Estimating the value of a consumer involves predicting the probability of a consumer action and assigning a value to the consumer based on revenue or another contribution generated by the consumer action.

Models that rely on clickstream data alone, however, may present disadvantages. For example, in the context of an online service, limited clickstream data may be available for new or prospective consumers that have not used the online service at all or have not used the online service extensively. Thus, an automated modeling system that relies solely on clickstream data (or clickstream data in combination with user profile) may suffer from a “cold start” problem in that actions of relatively new users cannot be predicted with accuracy. Furthermore, even with existing consumers, solutions that use clickstream data may provide an incomplete picture of a consumer's intentions or dispositions. For example, these solutions fail to utilize data gathered from person-to-person interactions (e.g., conversations via email, phone, instant-messaging, etc.).

### SUMMARY

Certain embodiments involve training classification algorithms to predict end-user behavior based on historical conversation data. For example, a computing system accesses training data with conversational and non-conversational data. The computing system derives decision points from a textual analysis of the conversational training data. The computing system also fits a hidden Markov model, which includes multiple hidden states, to the non-conversational data. The computing system groups observations from the non-conversational data and the derived decision points into data segments, where a particular data segment includes a subset of the observations and the decision points associated with at least one of the hidden states. The computing system generates, from each data segment, a corresponding predictive model for the associated hidden state. In some embodiments, the computing system subsequently determines that input non-conversational data for an entity likely corresponds to one of the hidden states. The computing system generates a predicted behavior by applying the predictive model for that hidden state to both input conversational data and the input non-conversational data for the entity.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 depicts an example of a network environment for training classification algorithms to predict end-user behavior using relationship data generated by a relationship management tool, according to certain embodiments of the present disclosure.

FIG. 2 depicts an example of a communications flow for generating and applying a consumer reaction model that predicts decisions or other behavior by consumers or other end users, according to certain embodiments of the present disclosure.

FIG. 3 depicts an example of a process for generating the consumer reaction model of FIG. 2, according to certain embodiments of the present disclosure.

FIG. 4 depicts an example of generating and applying the consumer reaction model of FIG. 2 using conversational data and sales journey data for consumers, according to certain embodiments of the present disclosure.

FIG. 5 depicts examples of criteria used to evaluate a model of hidden states that are predictive of consumer decisions or behavior, according to certain embodiments of the present disclosure.

FIG. 6 depicts examples of observations and decision points for users and examples of sets of hidden states associated with the observations, according to certain embodiments of the present disclosure.

FIG. 7 depicts an example of generating a first data segment that includes observations and decision points associated with a first one of the hidden states depicted in FIG. 6, according to certain embodiments of the present disclosure.

FIG. 8 depicts an example of generating a second data segment that includes observations and decision points associated with a second one of the hidden states depicted in FIG. 6, according to certain embodiments of the present disclosure.

FIG. 9 depicts an example of generating a third data segment that includes observations and decision points associated with a third one of the hidden states depicted in FIG. 6, according to certain embodiments of the present disclosure.

FIG. 10 depicts examples of evaluation scores for consumer reaction models generated using one or more of the operations depicted in FIGS. 2-9, according to certain embodiments of the present disclosure.

FIG. 11 depicts an example of a computing system that performs certain operations described herein, according to certain embodiments of the present disclosure.

### DETAILED DESCRIPTION

The present disclosure includes systems and methods for training classification algorithms to predict end-user behavior based on historical conversation data. As explained above, conventional solutions for simulating the behavior of users with respect to online services are limited by their reliance on clickstream data, which may provide an incomplete picture of users' behavior and thereby result in predictive models with reduced accuracy. Certain embodiments described herein improve the performance of automated modeling systems by, for example, using conversation data to generate or augment predictive models. For example, automated modeling systems described herein are used to map certain quantifiable features of conversational data, non-conversational data, or both to corresponding “states” of a consumer (or other end user), where the states are derived using the non-conversational data. The automated modeling systems build predictive models based on this mapping of user states to quantifiable conversation features. In some embodiments, using these quantifiable conversation features to train predictive models improves the accuracy with which an automated modeling system predicts certain user behaviors for a particular user state.

The following non-limiting example is provided to introduce certain embodiments. In this example, an automated modeling system includes one or more computing systems that execute a training module and a relationship management tool. The training module is used to generate a consumer reaction model based on relationship data generated by the relationship management tool (e.g., records of sales tasks involving a consumer, records of email exchanges between a salesperson and a user, etc.). The consumer reaction model is used to predict the behavior of certain consumers based on conversational data associated with those consumers, which in turn facilitates subsequent communications with the user that are tailored to the user's predicted behavior.

The consumer reaction model includes a set of trained predictive models. Each predictive model corresponds to a certain latent (or “hidden”) state of a consumer whose behavior is simulated using the automated modeling system. For instance, the consumer reaction model may be used for predicting the behavior of consumers along different points of a sales journey. A sales journey model may include an “awareness” mindset, in which the consumer begins learning about a particular product or service, as well as a “consideration” mindset, in which the consumer evaluates the suitability of the product or service for the consumer's needs. Latent states are used to model these mindsets of consumer. These states are “latent” or “hidden” because the modeled mindset itself (e.g., a consumer's “awareness” or “consideration” of a product) cannot be directly observed. The training module of the automated modeling system determines these latent states based on observable actions that involve the consumer and that correspond to the various states.

Continuing with this example, the training module generates the predictive models in the consumer reaction model by using conversational data from the relationship management tool. The conversational data is segmented according to the hidden states identified by the training module. For example, the relationship management tool captures or accesses stored conversational data from certain time periods (e.g., email exchanges, instant-messaging conversations, transcripts of phone calls, etc.). The training module obtains this conversational data for training the consumer reaction model. The training module derives certain quantifiable features from the conversational data using a textual analysis algorithm. For instance, the textual analysis algorithm classifies certain portions of a particular conversation as involving decision points in a sales journey (e.g., expressions of concern over a product, requests for a meeting regarding the product, etc.). In addition, the training module identifies the hidden states of a sales journey using suitable non-conversational data provided by the relationship management tool (e.g., data describing discrete tasks tracked with the relationship management tool). The training module identifies the hidden states by, for example, fitting a hidden Markov model to the non-conversational data.

The training module uses the identified states and the quantifiable features derived from the conversational data to train the predictive models. For example, the training module determines that a particular hidden state existed during a certain time period in a sequence of training data. The training module selects a data segment that includes a subset of the quantifiable conversational features (e.g., decision points) corresponding to the time period for the particular hidden state. The training module fits a logistic regression model or other suitable predictive model to the data segment for that hidden state, thereby producing a predictive model specific to the hidden state. The training module repeats this process for each of the hidden states. As a result, the training module of an automated modeling system outputs a consumer reaction model having multiple predictive models. Each predictive model in the consumer reaction model is capable of predicting a certain user behavior (e.g., a conversion) if the user is in a particular hidden state.

As used herein, the term “conversational data” is used to refer to one or more text strings that describe or otherwise indicate informal exchanges (either verbal or written) of information between at least two individuals. Examples of conversational data include instant-messaging logs, email exchanges, transcripts of telephone conversations, and other records of natural language exchanges between two or more participants. In some embodiments, conversational data is unstructured. For example, two different records of two different conversations may include data that is not subject to any constraints regarding numbers of words, terms used during the discussion, etc.

As used herein, the term “decision point” is used to refer to a quantifiable or qualitative feature of conversational data that is usable for predicting a behavior of a user. Examples of these decision points include action classifications (e.g., “meeting” or “request”) for a conversation, sentiment classifications (e.g., “positive,” “negative,” “concerned,” or “neutral”) for a conversation, etc. In some embodiments, a decision point is determined by applying a support vector machine or other suitable natural-language processing algorithm to a set of conversation data.

As used herein, the term “non-conversational data” is used to refer to data describing discrete electronic interactions or operations (or sets of electronic interactions or operations) performed in one or more online tools, data describing some characteristic of a set of electronic interactions or operations (or sets of electronic interactions or operations) performed in one or more online tools, or some combination thereof. One example of non-conversational data is clickstream data. Another example of non-conversational data is a constrained set of tasks that may be performed via a relationship management tool. For instance, a relationship management tool may require an operator to describe interactions with consumers using a discrete set of tasks and associated task statuses. Another example of non-conversational data, such as describing some characteristic of a set of electronic interactions or operations, is the time elapsed since a previous conversation, which can be derived from the difference in timestamps applied to two interactions via a relationship management tool.

As used herein, the terms “hidden state” and “latent state” are used to refer to un-observed states in a model that correspond to one or more observed features in a set of training data. For instance, observable data, such as clickstream data, may be used to derive latent states that model user intentions or dispositions that resulted in the online interactions from which the clickstream data was generated.

As used herein, the term “relationship management tool” is used to refer to one or more applications, online services, or combinations thereof that include tools for tracking interactions between entities (e.g., sales personnel and leads, sales personnel and customers, customer service representatives, etc.), performing tasks pursuant to a relationship between entities, etc. A relationship management tool can include features for capturing conversational data. Examples of features for capturing conversational data include email tools, instant-messaging tools, call-recording tools, call-transcription tools, tools for importing conversational data from other programs (e.g., dedicated email or instant-messaging programs), etc. Additionally or alternatively, a relationship management tool can include features for capturing non-conversational data. Examples of features for capturing conversational data include task-tracking tools, analytical sales tools, tools for tracking consumer concerns or issues, lead management tools, etc. Examples of relationship management tools include Adobe® Social, Adobe® Analytics, Adobe® Campaign, etc.

Certain embodiments described herein facilitate using conversational data for predicting the behaviors of consumers or other end users. Examples of conversational data include narrative data describing verbal conversations among individuals (e.g., conversations with sales leads, follow-up conversation with from existing consumers, social conversations, etc.). Examples of predicted behaviors include a conversion of a prospective consumer, a defection of an existing consumer, positive or negative feedback about electronic content available via an online service (e.g., content describing a brand on a social media website), etc. In some embodiments, relationship management tools are used to assess the value of certain consumers based on these predicted behaviors. The predicted behaviors, the assigned values, or both allow a user of the relationship management tool to take appropriate action in response to a certain prediction (e.g., changing a salesperson's response to a consumer's inquiry if the conversation indicates an expression of concern rather than an expression of interest). The use of conversational data in real-time allows the behavior of consumers and other end users to be predicted even if little or no clickstream data is available for the end user.

Example of an Operating Environment for Generating a Reaction Model

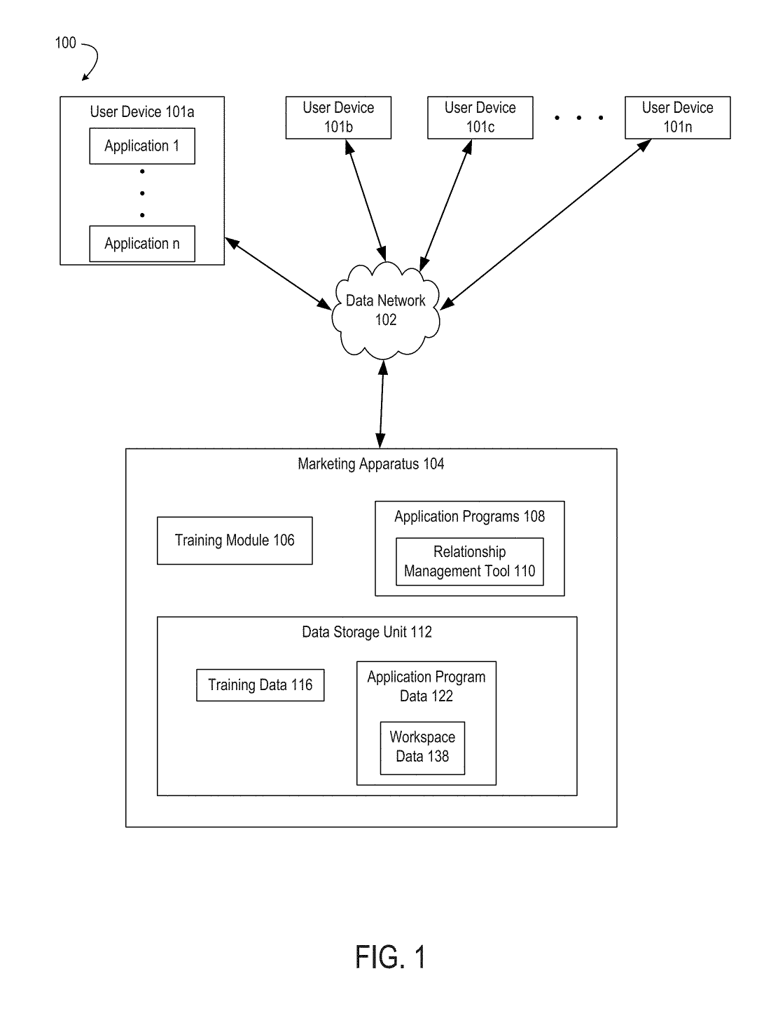

Referring now to the drawings, FIG. 1 depicts an example of a network environment 100 for training classification algorithms to predict end-user behavior based on historical conversation data, according to certain embodiments of the present disclosure. In the example depicted in FIG. 1, various user devices 101a-n access a marketing apparatus 104 via a data network 102. The marketing apparatus 104 executes one or more training modules 106 (or other suitable program code) for performing one or more functions used in generating a consumer reaction model from training data 116.

A consumer reaction model can be used for predicting the behavior of an end user, such as a consumer, based on conversation with that user. In a non-limiting example, conversational data includes records such as email exchanges, transcripts of phone calls, or other unstructured data describing verbal or written discussions between two entities. Examples of these entities include sales personnel, prospective customers, and existing customers. A relationship management tool 110 uses the trained consumer reaction model to predict the behavior of consumers and to automatically suggest appropriate actions based on the predictions.

Some embodiments of the network environment 100 include user devices 101a-n. Examples of a user device include, but are not limited to, a personal computer, a tablet computer, a desktop computer, a processing unit, any combination of these devices, or any other suitable device having one or more processors. A user of the user device 101 uses various products, applications, or services supported by the marketing apparatus 104 via the data network 102.

The marketing apparatus 104 includes one or more devices that provide and execute one or more engines for providing one or more digital experiences to the user. The marketing apparatus 104 can be implemented using one or more servers, one or more platforms with corresponding application programming interfaces, cloud infrastructure, and the like. In addition, each engine can also be implemented using one or more servers, one or more platforms with corresponding application programming interfaces, cloud infrastructure, and the like.

Each of the user devices 101a-n is communicatively coupled to the marketing apparatus 104 via the data network 102. Examples of the data network 102 include, but are not limited to, internet, local area network (“LAN”), wireless area network, wired area network, wide area network, and the like.

The marketing apparatus 104 includes a data storage unit 112. The data storage unit 112 can be implemented as one or more databases or one or more data servers. The data storage unit 112 includes training data 116 that is used by the training module 106 and other engines of the marketing apparatus 104, as described in further detail herein.

The marketing apparatus 104 hosts one or more application programs 108, which can include the relationship management tool 110, to facilitate the creation of digital experiences for consumers or other end users. The marketing apparatus 104 provides the applications (e.g., the relationship management tool 110) as a software as a service (“SaaS”), or as a standalone application that can be installed on a computing device (e.g., a device used by a marketer), or as a combination of both. In addition, a workspace is included within each application program. The workspace data 138, which is included within application program data 122, includes settings of the application program, settings of tools or settings of user interface provided by the application program, and any other settings or properties specific to the application program.

Examples of Operations for Building a Reaction Model

As described in detail with respect to the various examples below, the training module 106 is used to develop and use a consumer reaction model according to various embodiments. For instance, a consumer reaction model is trained, optimized, generated, or otherwise modified by the training module 106. The consumer reaction model is used to predict decisions made by a consumer or other behavior of a consumer. For illustrative purposes, the reaction models described herein are described with using simplified examples involving consumers, sales personnel, and sales journey. But the operations described herein can be applied to any automated modeling system that can use hidden states derived from non-conversational data to build a predictive model from conversational data.

In an illustrative example, the consumer reaction model allows a computer-implemented relationship management tool 110 to simulate the decision-making process of a consumer or other end user. Simulating the decision-making process of a consumer or other end user allows the relationship management tool 110 to determine a probability that the consumer or other end user will purchase a product or service (e.g., the probability of a conversation), a probability that the consumer or other end user will abandon a transaction, a probability that the consumer or other end user will terminate a particular service, or other probabilities involving actions of a consumer or other end user.

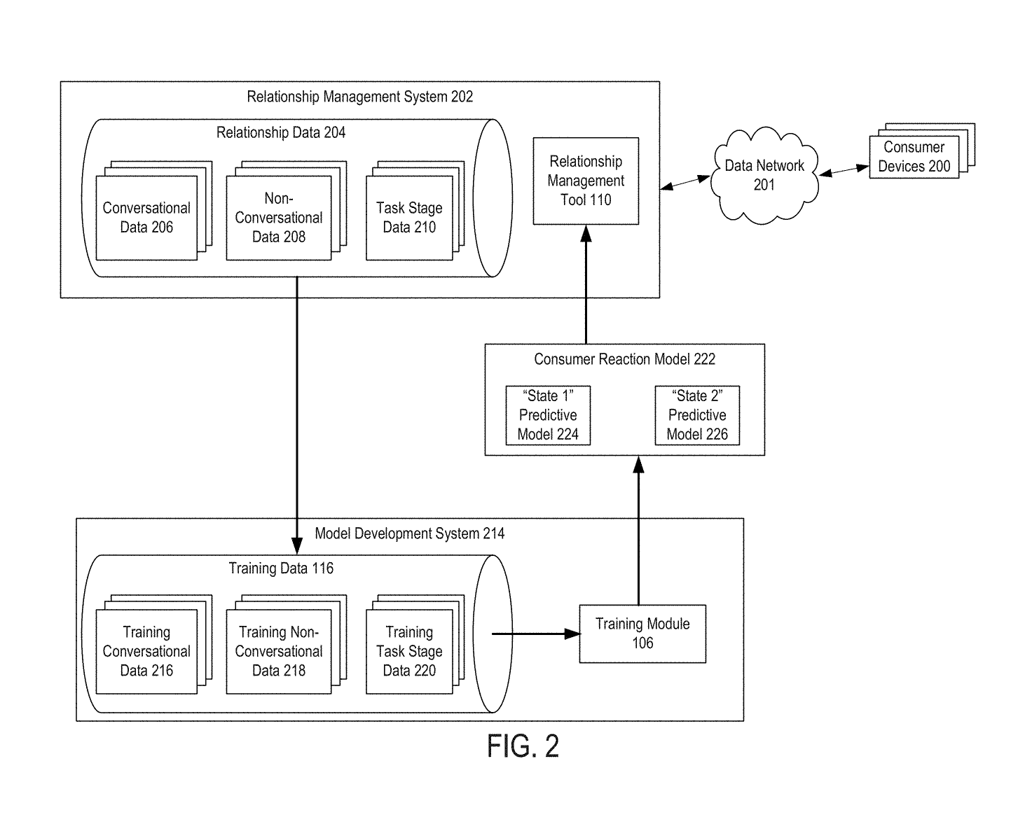

FIG. 2 depicts an example of a communications flow for generating and applying a consumer reaction model that predicts end-user decisions or other behavior, according to certain embodiments. In this example, the training module 106 (or other suitable program code) is executed to obtain at least some training data 116, either directly or indirectly, from a relationship management tool 110. The relationship management tool 110 is executed by a relationship management system 202, such as the marketing apparatus 104 depicted in FIG. 1 or another suitable computing system. The relationship management tool 110 is used to generate relationship data 204, which is stored in one or more computer-readable storage media that are included in or accessible to the relationship management system 202. The relationship data 204 includes conversational data 206, non-conversational data 208, and task stage data 210.

The relationship management tool 110 generates the conversational data 206, non-conversational data 208, and task stage data 210 based at least partially on user inputs (e.g., from sales personnel) as the relationship management tool 110 is used to manage one or more transactions involving an end-user. For example, the relationship management system 202 is used to communicate with one or more consumer devices 200 (e.g., tablet computers, smart phones, etc.). Examples of this communication include direct communication (e.g., emails, online chats, and other electronic communications via the relationship management tool 110) and indirect communication (e.g., person-to-person sales calls that are recorded, transcribed, or otherwise documented using the relationship management tool 110).

A model development system 214 obtains training data 116 from the relationship management system 202 (as depicted in FIG. 2) or from a non-transitory computer-readable medium accessed by the relationship management system 202 for storing the relationship data 204. For example, the model development system 214 selects at least some of the relationship data 204 for use as training data 116. In some embodiments, the model development system 214 includes computing hardware, such as a processing device that executes the training module 106 and a non-transitory computer-readable medium and associated data structures that store the training data 116. In one example, the model development system 214 communicates with the relationship management tool 110 and thereby selects, as a set of training data 116, some or all of the conversational data 206 as training conversational data 216. The model development system 214 also selects some or all of the non-conversational data 208 as the training non-conversational data 218. The model development system 214 also selects some or all of the task stage data 210 as the training task stage data 220.

The model development system 214 executes the training module 106 to generate, train, or otherwise develop a consumer reaction model 222 based on the training data 116. The training module 106 outputs the consumer reaction model 222 for use by a relationship management tool 110. Examples of outputting the consumer reaction model 222 include transmitting the consumer reaction model 222 to a computing device that executes the relationship management tool 110, storing the consumer reaction model 222 in a non-transitory computer-readable medium accessible by the relationship management tool 110, etc.

The relationship management tool 110 can use the consumer reaction model 222 to predict the behavior of an end-user. For example, the consumer reaction model 222 depicted in FIG. 2 includes a first predictive model 224 applicable to a first state (i.e., “State 1”) of an end-user and a second predictive model 226 applicable to a second state (i.e., “State 2”) of the end-user. As an illustrative example, a first state may be an “awareness” stage of a sales journey by a consumer, in which the consumer begins learning about a particular product or service. A second state may be a “consideration” stage of a sales journey by the consumer, in which the consumer evaluates the suitability of the product or service for the consumer's needs.

Continuing with this example, the relationship management tool 110 uses “live” data (or other input data) about a consumer (e.g., a set of sales journey data for a lead or existing consumer) to determine whether that particular consumer is in the first state or the second state. For instance, the relationship management tool analyzes a certain sequence of input data points, which are obtained or derived from non-conversational interactions with the consumer, and thereby determines that the consumer is in “State 1.” Based on this determination, the relationship management tool 110 selects the predictive model 224 for “State 1.” The relationship management tool 110 applies the selected predictive model 224 to input data for the particular consumer. The input data includes data about various attributes that are obtained or derived from both non-conversational interactions with the consumer and conversational interactions with the consumer. Applying the predictive model 224 to the input data for the particular consumer generates a predictive output for the consumer by using the attributes as predictor variables for the model. The predictive output indicates a probability of the user performing some action of interest (e.g., purchasing a product, terminating a service, etc.).

For illustrative purposes, FIG. 2 depicts a consumer reaction model 222 having two states and two corresponding predictive models. But any suitable number of states for consumers (or other end users) may be identified using the training module 106. Furthermore, any number of predictive models, which correspond to hidden states, may be generated for the consumer reaction model 222 using the training module 106.

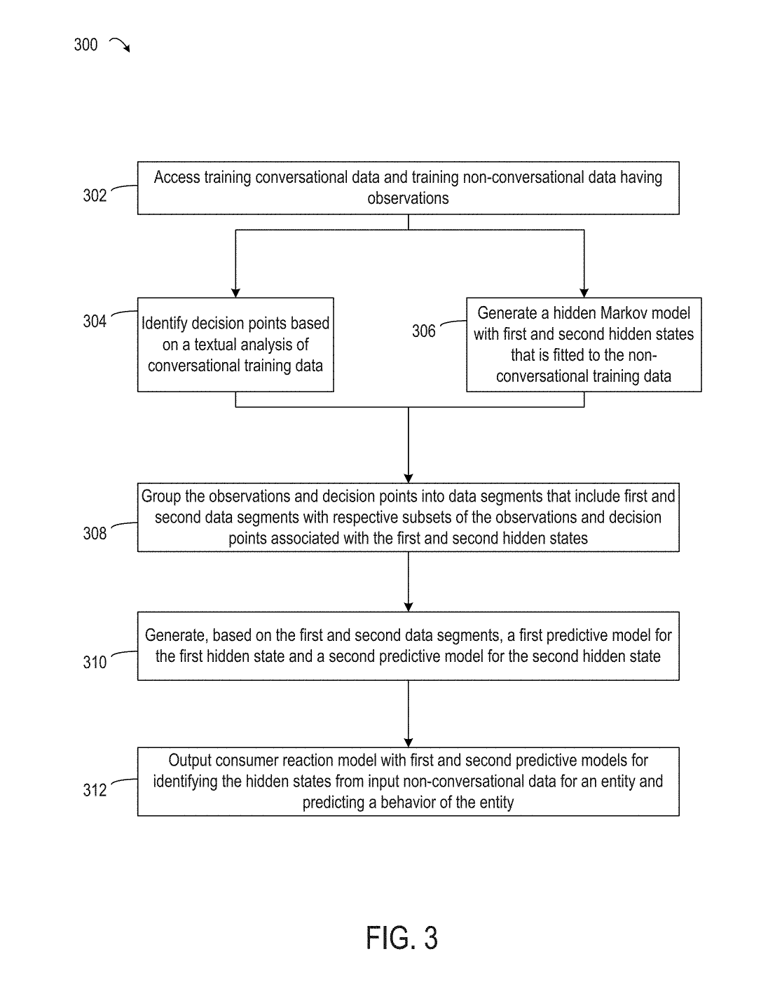

The consumer reaction model 222 can be generated using one or more operations described herein. For instance, FIG. 3 depicts an example of a process 300, which may be performed by the marketing apparatus 104 or another suitable computing system, that generates a consumer reaction model for predicting end-user behavior based on historical conversation data, according to certain embodiments. In some embodiments, one or more processing devices implement operations depicted in FIG. 3 by executing suitable program code (e.g., the training module 106). For illustrative purposes, the process 300 is described with reference to certain examples depicted in the figures. Other implementations, however, are possible.

At block 302, the process 300 involves accessing training conversational data and training non-conversational data, where the non-conversational data includes various data observations. In one example, a set of training data 116 includes training conversational data 216, training non-conversational data 218, and data 220 as described above with respect to FIG. 2. At least some of the training non-conversational data 218 includes data describing (or otherwise indicating) observable features. For instance, a relationship management tool 110 may generate data regarding discrete, observable attributes of a particular journey or other relationship between a pair of entities, such as a sales entity and a consumer or lead. Examples of these attributes include a status of a task related to the journey, an amount of time since a previous communication with the consumer or lead, and a serial number assigned to a communication with the consumer or lead.

A processing device executes one or more training modules 106 (or suitable other program code) to implement block 302. For example, the program code for the training module 106, which is stored in a non-transitory computer-readable medium, is executed by one or more processing devices. Executing the training module 106 causes the processing device to access the training data 116 from the same non-transitory computer-readable medium or a different non-transitory computer-readable medium. In some embodiments, accessing the training data involves communicating, via a data bus, suitable signals between a local non-transitory computer-readable medium and the processing device. In additional or alternative embodiments, accessing the training data involves communicating, via a data network, suitable signals between a computing system that includes the non-transitory computer-readable medium and a computing system that includes the processing device.

At block 304, the process 300 involves using a textual analysis algorithm to identify decision points from the training conversational data. For example, conversations between two entities (e.g., a sales entity and a consumer or lead) include unstructured data such as email correspondence, instant messaging conversations, transcripts of verbal conversations, notes of verbal conversations, etc. This unstructured data is unsuitable for training a model to simulate decisions by a consumer that may be predicted using the conversational data (as well as other types of relationship data). A training module 106 generates a set of data suitable for training a classifier algorithm by deriving, from this unstructured conversation data, discrete, quantifiable decision points.

A processing device executes one or more training modules 106 or other program code to implement block 304. In one example, the program code for the training module 106, which is stored in a non-transitory computer-readable medium, is executed by one or more processing devices. Executing the training module 106 causes the processing device to perform one or more textual analysis algorithms. The textual analysis algorithm is used for computing one or more term frequency—inverse document frequency (“TF-IDF”) statistics for textual content in a document with conversational data. The textual analysis algorithm uses the TF-IDF statistics, as well as any other suitable features, as inputs to a multi-class support vector machine (or other suitable classification algorithm). The multi-class support vector machine (or other suitable classification algorithm) outputs sets of decisions points that are identified from the unstructured conversation data. For example, a transcript of a conversation with a particular consumer or lead over a particular time period can be analyzed to identify one or more requests, meeting proposals, concerns, or other discrete features of the conversation. A feature vector or other suitable data structure can be generated by a training module 106 to store numbers of these requests, meeting proposals, concerns, or other discrete features of the conversation along with data identifying the relevant time period for the conversation. The training module 106 causes one or more processing devices to store the feature vectors or other data structures, which include decision point data derived from a textual analysis algorithm, in a non-transitory computer-readable medium for use by the process 300.

At block 306, the process 300 involves generating a hidden Markov model that is fitted to the training non-conversational data. The hidden Markov model includes multiple states. For illustrative purposes, the process 300 is described as generating a hidden Markov model with at least a first hidden state and a second hidden state, although any number of states can be used. The hidden states are latent characteristics of an end user that impact a reaction or other decision by the end user, such as the stages of a decision-making process used by a consumer (e.g., awareness, consideration, decision). These latent (i.e., “hidden”) characteristics are not directly observable from actions performed by the end user or otherwise involving the end user. But the latent characteristics may be estimated or otherwise determined from observable actions using a hidden Markov modeling process.

A processing device executes the training module 106 or other program code to implement block 306. For example, the program code for the training module 106, which is stored in a non-transitory computer-readable medium, is executed by one or more processing devices. In some embodiments, executing the program code causes a computing system to perform one or more operations that generate the hidden Markov model of block 306, such as retrieving, from a non-transitory computer-readable medium, relevant training data about observations during a time period of interest (e.g., various sequences of non-conversational observations that have been recorded using the relationship management tool 110).

For example, the training module 106 selects training sequences of observations from the training non-conversational data. Each observation includes one or more discrete, observable features associated with respective increments of a time period (a sequence of tasks performed over a period of hours, days, months, etc.). These observable features may include, for example, features of tasks that are performed with respect to a consumer or other entity via a relationship management tool 110.

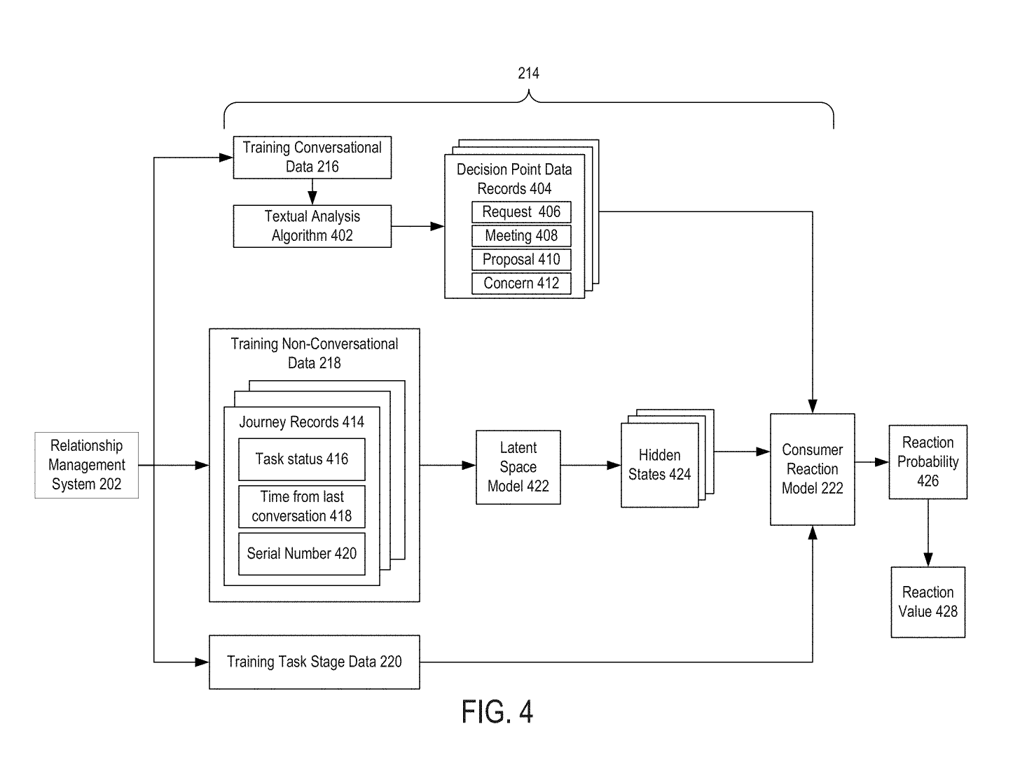

In an illustrative example involving a sales journey for a lead, the observable features include, for each increment in a certain time period, features such as a time since a sales entity last contacted the lead, a status of a task associated with a lead, and a serial number of a communication with a lead. These task features may be captured (i.e., stored in a suitable data structure of a non-transitory computer-readable medium) using a relationship management tool 110. The training module 106 generates a hidden Markov model by fitting the selected training sequences of observations to a corresponding Markov chain with a certain number of hidden states. In embodiments, the training module 106 is used to identify the number of hidden states subject to one or more constraints. For example, the training module 106 may adjust the number of hidden states used by the hidden Markov model such that a suitable model-selection function is minimized. Examples of these constraints, as well as examples of generating a hidden Markov model, are described in further detail with respect to FIG. 4.

At block 308, the process 300 involves grouping the observations in the non-conversation data and decision points generated at block 304 into data segments. Each data segment includes a respective subset of the observations and decision points corresponding to or otherwise associated with one or more one of the hidden states identified at block 306. For example, the training module 106 identifies, from the hidden Markov model, a first subset of observations from the non-conversational data that correspond to or are otherwise associated with a first hidden state and a second subset of observations from the non-conversational data that correspond to or are otherwise associated with a second hidden state. (For illustrative purposes, the process 300 is described as identifying a first data segment with observations and decision points corresponding to a first hidden state and a second data segment with observations and decision points corresponding to a second hidden state, although any suitable number of states and data segments can be used.)

The observations that correspond to (or are otherwise associated with) certain hidden states include portions of the training non-conversational data 218 that have a threshold probability (e.g., the highest probability) of resulting in particular hidden state values within the hidden Markov model at particular points in time. As described in further detail herein, if a sequence of observations X, Y, and Z has a sufficiently high probability of being associated with a sequence of hidden states A, B, and C, the training module 106 can select observation X as part of a data segment for hidden state A, select observation Y as part of a data segment for hidden state B, and select observation Z as part of the data segment for hidden state C. Similarly, if another sequence of observations W, Z, and Y has a sufficiently high probability of being associated with a sequence of hidden states A, B, and C, the training module 106 can select observation W as part of the data segment for hidden state A, select observation Z as part of the data segment for hidden state B, and select observation Y as part of the data segment for hidden state C.

For instance, in an example involving a sales journey, a first data segment corresponds to an “awareness” state of the sales journey existing a time t₁ and includes a subset of observations that has a sufficiently high probability of being being associated with the “awareness” state having existed at the time t₁. The training module 106 selects this subset of observations and assigns the selected observations to the first data segment. The training module 106 also selects certain decision points (i.e., the discrete feature derived from the training conversational data 216) that existed at the time t₁ and assigns the selected decision points to the first data segment. Similarly, a second data segment corresponds to a “consideration” state of the sales journey existing a time t₂, and includes a subset of observations that have a sufficiently high probability of being associated with the “consideration” state having existed at the time t₂. The training module 106 selects this subset of observations and assigns the selected observations to the second data segment. The training module 106 also selects other decision points (i.e., the discrete feature derived from the training conversational data 216) that existed at the time t₂ and assigns the selected decision points to the second data segment. In a similar manner, the training module 106 can group additional observations and decision points into additional data segments for additional hidden states.

In some embodiments, a particular observation or type of observation may be assigned to multiple data segments. For instance, the same email content may be observed in both a first sequence and a second sequence. In the first sequence of observations, the observation involving the email content can have a high probability of being mapped to a first hidden state. In the second sequence of observations, the observation involving the email content can have a high probability of being mapped to a second hidden state.

A processing device executes the training module 106 or other program code to implement block 308. For example, the program code for the training module 106, which is stored in a non-transitory computer-readable medium, is executed by one or more processing devices. In some embodiments, executing the program code causes a computing system to perform one or more operations that perform the data-segmentation operations of block 308. Examples of operations for segmenting the training data 116 based on the hidden states of the hidden Markov model are described in more detail with respect to FIG. 4.

At block 310, the process 300 involves generating, based on the data segments, different predictive models for the various hidden states. In some embodiments, each predictive model is generated by training a certain type of model (e.g., a logistic regression model) using a respective one of the data segments. A processing device executes the training module 106 or other program code to implement block 310. For example, the program code for the training module 106, which is stored in a non-transitory computer-readable medium, is executed by one or more processing devices. In some embodiments, executing the program code causes a computing system to perform one or more operations that perform the model-training operations of block 310.

In one example, the training module 106 generates first and second logistic regression models (or other suitable predictive models) using respective first and second data segments selected for training the logistic regression models or (or other suitable predictive models). The first data segment is selected for training a predictive model for the first hidden state, and the second data segment is selected for training a predictive model for the second hidden state. The first logistic regression model is generated by determining an appropriate set of logistic regression coefficients that are applied to predictor variables in the model. For example, input attributes in the first data segment (e.g., sets of decision points derived from the training conversational data 216, sets of observations obtained from the training non-conversational data 218, etc.) are used as the predictor variables. The logistic regression model with the determined set of coefficients is outputted as the first predictive model. The logistic regression coefficients are used to transform or otherwise map these input attributes into particular outputs in the training data 116 (e.g., conversions, abandonments, etc.). Likewise, the second logistic regression model is generated by determining another set of appropriate logistic regression coefficients. This additional set of logistic regression coefficients is used to transform or otherwise map various input attributes from the second data segment into particular outputs in the training data 116 (e.g., conversions, abandonments, etc.). The logistic regression model with the additional set of coefficients is outputted as the second predictive model. This process can be repeated for each data segment generated by the process 300.

At block 312, the process 300 involves outputting a consumer reaction model having the various predictive models corresponding to the various hidden states. The consumer reaction model is usable for identifying hidden states from input non-conversational data for an entity and predicting a behavior of the entity using the input non- conversational data as well as input conversational data for the entity. For example, if the relationship management tool 110 has access to a consumer reaction model 222, the relationship management tool 110 can access input conversational data and non-conversational data about a particular consumer or other end user. The relationship management tool 110 can analyze a sequence of observations from the input conversational data and identify, from the sequence of observations, an associated hidden state from the hidden Markov model. The relationship management tool 110 selects this associated hidden state based on, for example, the hidden state being included in a hidden-state sequence that has a sufficiently high likelihood of explaining the input sequence of observations. The relationship management tool 110 selects the relevant predictive model for that hidden state (e.g., the relevant set of logistic regression coefficients) and applies the selected predictive model to the sequence of observations and to any decision points that are derived from input conversational data. Applying the selected predictive model results in a suitable predictive output for the relevant entity (e.g., a probability of a consumer performing some action with respect to an online service).

A processing device executes the training module 106 or other program code to implement block 312. For example, the program code for the training module 106, which is stored in a non-transitory computer-readable medium, is executed by one or more processing devices. In some embodiments, executing the program code causes a computing system to output the consumer reaction model by transmitting the consumer reaction model from a first computing system, which generates the consumer reaction model, to a second computing system, which executes a relationship management tool 110. In some embodiments, executing the program code causes a computing system to output the consumer reaction model by transmitting the consumer reaction model from a processing device to a non-transitory computer-readable medium via a data bus of a computing system, thereby making the consumer reaction model available to a relationship management tool 110 that is executed at the computing system. In these various embodiments, the executed relationship management tool 110 applies the consumer reaction model to predict the decisions or other behavior of a particular end-user.

For illustrative purposes, FIG. 3 and the accompanying description above refer to first and second hidden states, first and second data segments, and first and second predictive models. But implementations with different numbers of hidden states, data segments, and predictive models are possible. For instance, in some embodiments, the training model identifies a number of hidden states by balancing various aspects of a latent space model (e.g., data fitting, complexity, etc.). The number of hidden states may be greater than two.

The following example is provided to illustrate a potential application of the operations described above. In particular, FIG. 4 depicts an illustrative example of generating and applying the consumer reaction model using conversational data and sales journey data for consumers. In this example, a “value” for a consumer is estimated based on conversations with a user.

In the example depicted in FIG. 4, a trained regression model (or other predictive model) is generated for predicting the probability of an end-user's behavior (e.g., a consumer reaction to a sales call). A relationship management system 202 is used to generate training conversational data 216, training non-conversational data 218, and, in some embodiments, training task stage data 220. Examples of generating this training data are described above with respect to FIG. 2. The model development system 214 uses this training data to generate a consumer reaction model 222, which is usable for determining a reaction probability 426 (e.g., a conversion probability, an abandonment probability, etc.) from which a reaction value 428 is calculated. An example of a reaction value 428 is the value of a particular consumer in view of the consumer's conversion probability.

The model development system 214 analyzes training conversational data 216 to identify decision points. For instance, the model development system 214 executes a textual analysis algorithm 402 using, as inputs, conversation data from various consumers over different time periods. One example of the textual analysis algorithm 402 is an algorithm that determines TF-IDF statistics using a bigram features analysis. The textual analysis algorithm 402 derives decision point data records 404 from the training conversational data 216. For example, a given decision point data record 404 corresponds to a particular conversation that occurred in a particular time period, as described by a portion of the training conversational data 216 (e.g., a transcript of a sales call on a particular date). The decision point data record 404 includes data indicating that the conversation involved one or more of a request 406, a meeting 408, a proposal 410, and a concern 412.

The model development system 214 also develops a latent space model 422 based on sales journey records 414 from the training non-conversational data 218. The latent space model 422 identifies hidden states 424 (or “latent states”) in a sales journey. The sales journey can include the sequence of different tasks between initial contact with a consumer and a conversion. Hidden states for a sales journey can indicate, for example, a consumer's different states of mind during the sales journey, such as an “awareness” state in which the consumer becomes aware of a product, an “interest” state in which the consumer becomes knowledgeable about the product, a “desire” state in which the consumer wishes to purchase the product, and an “action” state in which the consumer decides to purchase the product.

A hidden Markov model captures a probability of moving from one latent state to another latent state. For example, a four-by-four Markov matrix for the four states described in the example above includes probabilities of moving between “interest” and “desire,” moving between “interest” and “action,” moving between “awareness” and “action,” etc. The hidden Markov model also captures the probabilities of certain observable actions (e.g., certain online interactions occurring with respect to a consumer) occurring in each of the hidden states.

In some embodiments, the model development system 214 builds the latent space model 422 from journey records 414. A journey record 414 includes, or can be used to derive, a feature vector for a particular observation (also known as an “observables vector”) associated with a particular time period. For instance, a given journey record 414 may indicate a task status 416, a time from last conversation 418, and a serial number 420 associated with an action that has occurred at a certain time within a sales journey. The model development system 214 generates or otherwise obtains a feature vector having dimensions that respectively correspond to the task status 416, the time from last conversation 418, and the serial number 420.

The training non-conversational data 218 can include multiple sequences of these feature vectors over a time period. Each sequence of feature vectors corresponds to a particular consumer or other end user about which the relationship management system 202 has stored relationship data. Thus, a sequence of feature vectors for a particular consumer corresponds to a stream of tasks that are performed with respect to the user and that are described in the journey records 414 generated with the relationship management tool 110.

In one example, the model development system 214 uses a hidden Markov model as the latent space model 422. This latent space model 422 captures underlying patterns in buying behavior from the sales journeys described in the journey records 414. An example of a hidden Markov model is a Gaussian hidden Markov model. In a Gaussian hidden Markov model, a multivariate Gaussian is fit at each of the hidden nodes in the model, where the hidden nodes correspond to hidden states. Using the multivariate Gaussian accounts for multiple training observables (e.g., feature vectors corresponding to the journey records 414) at a particular hidden node. The latent space model 422 is trained based on various feature sets using log-likelihood scores of various versions of a hidden Markov model, where each version is obtained by training the model with sets of journey records 414.

For instance, in a hidden Markov model, the number of hidden states, which is configurable, determines the complexity of the model. The complexity of the hidden Markov model increases with the number of model parameters, which are in turn affected by the number of hidden states specified for the model. The model development system 214 uses one or more suitable criteria for evaluating the latent space model 422, where a suitable criterion balances the number of hidden states in the model, the complexity of over-fitting of the model, and the performance of the model.

Based on this consideration, the model development system 214 uses one or more or more suitable criteria for evaluating the latent space model 422. Evaluating the latent space model 422 involves selecting a suitable number of hidden states for the latent space model 422. In some embodiments, selecting a suitable number of hidden states for the latent space model 422 includes balancing model performance and model complexity.

For instance, the hidden Markov model (or other latent space model 422) can be evaluated based on an output of a suitable model-selection function. The model-selection function includes criteria for evaluating both the performance and complexity of the model. The training module 106 is used to iteratively generate different versions of the hidden Markov model with different numbers of hidden states. In each iteration, the training module 106 identifies a certain number of hidden states (either automatically or in response to a user input specifying the number of states). The training module 106 uses the identified number of hidden states to fit a hidden Markov model to a selected set of training sequences (i.e., sequences of different observations from the training non-conversational data 18). A version of the hidden Markov model that minimizes the model-selection function is selected as the latent space model 422.

Examples of criteria for balancing model performance and model complexity include an Akaike Information Criterion (“AIC”) and a Bayesian Information Criterion (“BIC”), which is a refinement of the AIC. One or both of the AIC and BIC may be used to evaluate a hidden Markov model. An example of an AIC model-selection function is:

AIC=−2log(L)+2q.

An example of a BIC model-selection function is:

BIC=−2log(L)+q log(n).

In these formulas, the term L is likelihood of a particular observation occurring in the training non-conversational data 218. The term q is the number of estimated parameters in the latent space model 422, which is dependent on the number of hidden states selected for the model. The term n is the number of data points in each training sequence from the set of training non-conversational data 218 that is used for developing the hidden Markov model. For example, a set of training sequences is selected from the training non-conversational data 218, where each training sequence includes n observed feature vectors over a time period and each feature vector indicates a particular task status 416, a particular time from last conversation 418, and a particular serial number 420 at a particular point in time within the observed time period.

In the AIC and BIC, the 2log (L) term rewards the latent space model 422 for the goodness of the fit on the training non-conversational data 218. For instance, the log-likelihood score on the data, which is provided by the term 2log(L), indicates the extent to which a predicted sequence of actions provided by a hidden Markov model accurately reflects observed sequences of actions in the training data. Furthermore, each of the AIC and BIC also includes penalty terms (e.g., the 2q term for the AIC and the q log(n) term for the BIC). Each penalty term is a function whose value increases if the number of estimated parameters in the latent space model 422 increases. The penalty term penalizes over-fitting in the model. In this manner, the 2log(L) term and the penalty term in the AIC and the BIC create a trade-off between fitting the model to the selected training data and reducing the complexity of the model.

The complexity of the hidden Markov model corresponds to the number of model parameters. For instance, estimated parameters for a Gaussian hidden Markov model include start probabilities for the respective hidden nodes, transition probabilities among hidden nodes, the means of feature vectors at the respective hidden nodes (i.e., the mean of observations associated with a particular hidden node), and the covariance matrices at the respective hidden nodes (i.e., the covariance among the observable features). In a Gaussian-hidden Markov model that includes N number of hidden nodes and F number of features in a feature vector, the start probabilities are a set of N−1 parameters, the transition probabilities are an additional set of N(N−1) parameters, the means of the feature vectors at the various hidden node are an additional set of N×F additional parameters, and the covariance matrices at each hidden node are an additional set of

$$N ( \frac{F ( F + 1 )}{2} )$$

parameters. Adding these sets of parameters results in

$$q = ( {N}^{2} - 1 ) + N \times F \times ( \frac{F + 3}{2} )$$

estimated parameters for the latent space model 422.

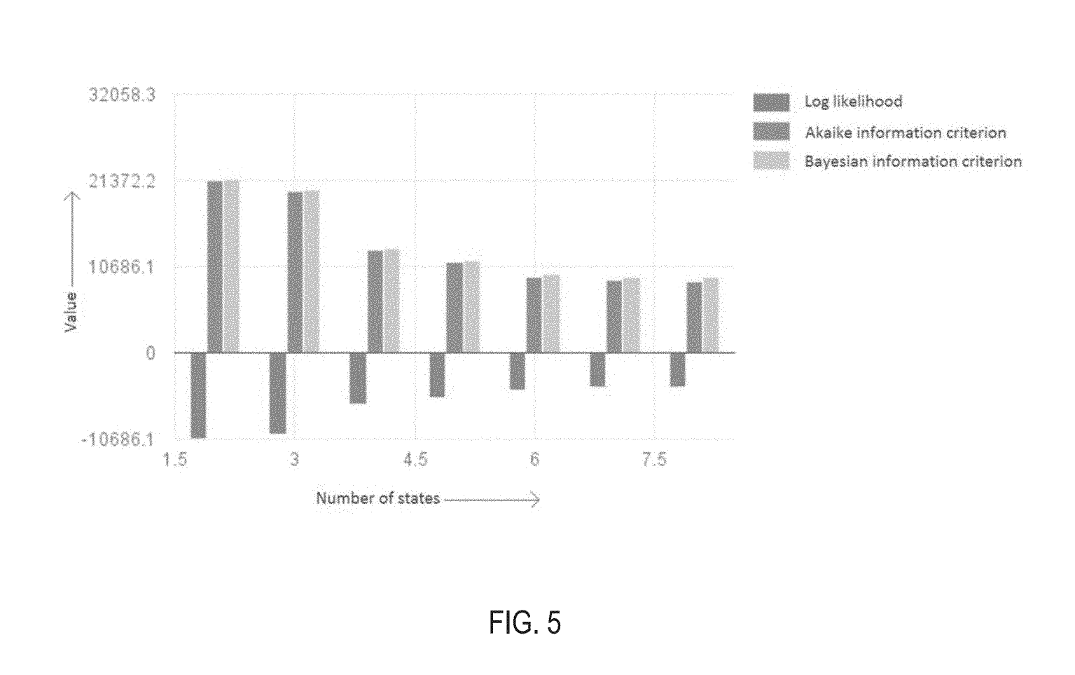

FIG. 5 depicts examples of plots of a log-likelihood, AIC, and BIC measures for different numbers of hidden states in a set of test data involving 326 journeys. As depicted in FIG. 5, the log-likelihood (e.g., the negatively valued plot) is slightly greater for eight hidden states than for seven hidden states. The increased log-likelihood a better fit for the training non-conversational data used in the example of FIG. 5. But the AIC and BIC measures are lower if seven hidden states are used for the latent space model 422 (i.e., a Gaussian hidden Markov model) than if eight hidden states are used. Thus, in this example, using seven hidden states (e.g., in the process 300 depicted in FIG. 3) provides a better trade-off between fit and complexity.

Returning to FIG. 4, in some embodiments, after training the latent space model 422, the model development system 214 trains a regression model or other predictive model at each of the hidden nodes of the latent space model 422. For instance, the model development system 214 uses the latent space model 422 to generate a consumer reaction model 222. The consumer reaction model 222 includes attributes corresponding to the decision points generated from the training conversational data 216, attributes corresponding to the journey records 414 in the training non-conversational data 218, and attributes corresponding to the training task stage data 220. These various attributes are predictors of a consumer's behavior. In some embodiments, a particular predictive model for a particular one of the hidden states 424 is represented by a weighted sum of these attributes (e.g., a logistic regression model), where the weights are sets of coefficients that correspond to the hidden state. The model development system 214 uses this training data to train a logistic regression model (or other suitable model) that can predict certain consumer behaviors in different scenarios that match the training data.

The training process involves comparing the particular tasks that have been completed in a journey to generate a prediction for the future of the journey. The information about the entire journey is captured in the hidden states that the hidden Markov model used for the latent space model 422. The resulting consumer reaction model 22 can be a logistic regression model that performs a binary classification of a consumer's potential reaction (e.g., predicting if the consumer journey is going to end with the consumer as “Booked” or “Lost”) as well as the reaction probability 426 of each classification. The reaction probability 426 of each classification can be used, for example, as a conversion likelihood for the consumer. The relationship management tool 110 or another suitable system can multiply the reaction probability 426 by a scalar value or other suitable weight to obtain a reaction value 428 (e.g., the value of a particular consumer for which input conversational data and non-conversational data is available).

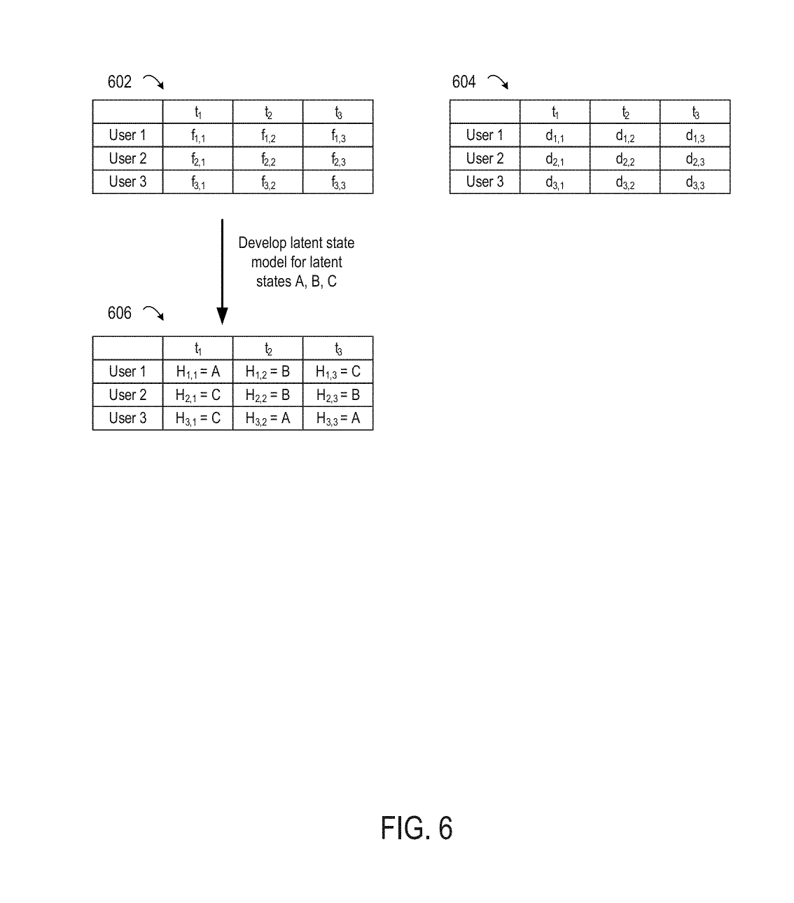

FIGS. 6-9 depict a simplified example of using latent states (which are identified from a latent space model) to segment data for training various logistic regression models (i.e., the predictive models in the consumer reaction model 222). As depicted in FIG. 6, the simplified example involves a set of observations 602 and a set of decision points 604. The observations 602 are selected or otherwise obtained from training non-conversational data. The decision points 604 are derived or otherwise obtained from training non-conversational data. The observations 602 include a first sequence of observations (denoted f_{1,1}, f_{1,2}, f_{1,3}) for User 1 (e.g., a consumer or other end user) at times t₁, t₂, and t₃. The observations 602 also include second and third sequences of observations for User 2 and User 3, respectively at times t₁, t₂, and t₃. The decision points 604 include a first sequence of decision points (denoted d_{1,1}, d_{1,2}, d_{1,3}) for User 1 at times t₁, t₂, and t₃. The decision points 604 also include second and third sequences of decision points for User 2 and User 3, respectively at times t₁, t₂, and t₃.

In this example, a hidden Markov model is generated from the observations 602, as described above with respect to FIGS. 3 and 4. The hidden Markov model indicates various sequences of hidden states 606 for the various users. For example, the hidden states 606 include a first sequence of hidden states (denoted H_{1,1}, H_{1,2}, H_{1,3}) for User 1 (e.g., a consumer or other end user) at times t₁, t₂, and t₃. The hidden states 606 also include second and third sequences of hidden states for User 2 and User 3, respectively at times t₁, t₂, and t₃. The hidden Markov model is optimized in the manner described above with respect to FIGS. 4 and 5 to include three possible hidden states (i.e., each hidden state can take one of the three values A, B, and C).

The set of hidden states 606 is provided for purposes of illustration. In some embodiments, a particular sequence of observations for a particular user may be associated with (e.g., explainable using) multiple sequences of hidden states. In one example, the sequence of observations for User 1 may be associated with a hidden-state sequence X (e.g., H_{1,1,X} followed by H_{1,2,X} followed by H_{1,3,X}), another hidden-state sequence Y (e.g., H_{1,1,Y} followed by H_{1,2,Y} followed by H_{1,3,Y}), and yet another hidden-state sequence Z (e.g., H_{1,1,Z} followed by H_{1,2,Z} followed by H_{1,3,Z}). In this example, the training module 160 determines that the sequence of observations for User 1 has various probabilities of being explained by the hidden-state sequences X, Y, and Z, respectively. The training module 160 selects one of the hidden-state sequences X, Y, and Z having a threshold probability (e.g., the highest probability) for inclusion in the set of hidden states 606. The training module 160 repeats this process for the sequences of observations associated with Users 2 and 3. In this manner, the set of hidden states 606 includes, for each user, a hidden-state sequence having the highest probability (or other specified probability) of explaining the observation sequence for that user.

In some embodiments, a particular observation or type of observation may be assigned to multiple data segments. For instance, the same email content may be observed for different users (e.g., both f_{1,1} and f_{2,1}), for different positions in a sequence (e.g., both f_{1,1} and f_{2,3}), or some combination thereof. In the first sequence of observations, the observation involving the email content can have a high probability of being mapped to a first hidden state. In the second sequence of observations, the observation involving the email content can have a high probability of being mapped to a second hidden state.

For illustrative purposes, the example depicted in FIG. 6 involves three users over the same time period having three time increments. But the training module 106 can generate hidden Markov models using training data involving any number of users, any number of time periods, and any number of time increments within a time period. Furthermore, an observable feature f, as depicted in FIG. 6, may be a value for a single feature, a vector having dimensions representing multiple features, or some combination thereof. Additionally or alternatively, a decision point d, as depicted in FIG. 6, may be a value for a single decision point, a vector having dimensions representing multiple decision points, or some combination thereof. Furthermore, although FIGS. 6-9 depict an illustrative example involving three hidden states, the training module 106 may use any suitable number of hidden states, such as a number of hidden states identified using the operations described above with respect to FIGS. 4 and 5.

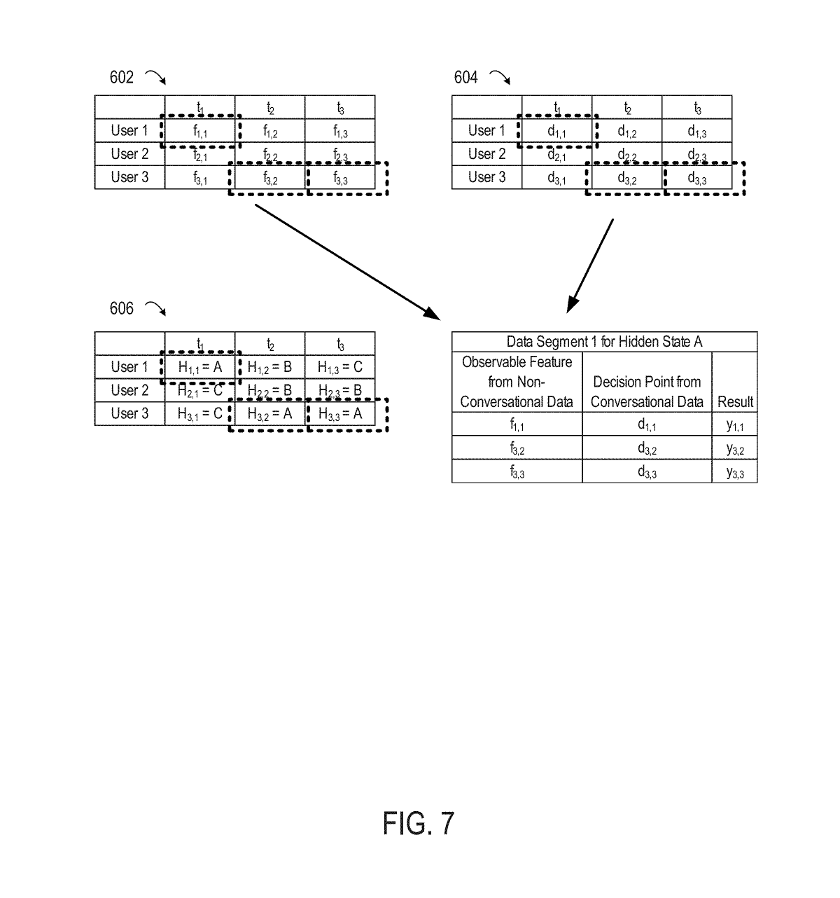

FIG. 7 depicts an example of segmenting the training data (i.e., the observations 602 and decision points 604) based on a first one of the hidden states 606. In this example, the training module 106 determines that User 1 was associated with the “A” hidden state at time t₁. Based on this determination, the training module 106 selects the corresponding observation f_{1,1} and decision point d_{1,1} for time t₁. Similarly, the training module 106 determines that User 3 was associated with the “A” hidden state at times t₂ and t₃, and therefore selects the corresponding observations and decision points for User 3 at times t₂ and t₃. The training module 106 assigns the selected observations and decision points to the data segment 1 that corresponds to the “A” hidden state. The training module 106 can train a logistic regression model or other predictive model for the “A” hidden state based on the data segment 1.

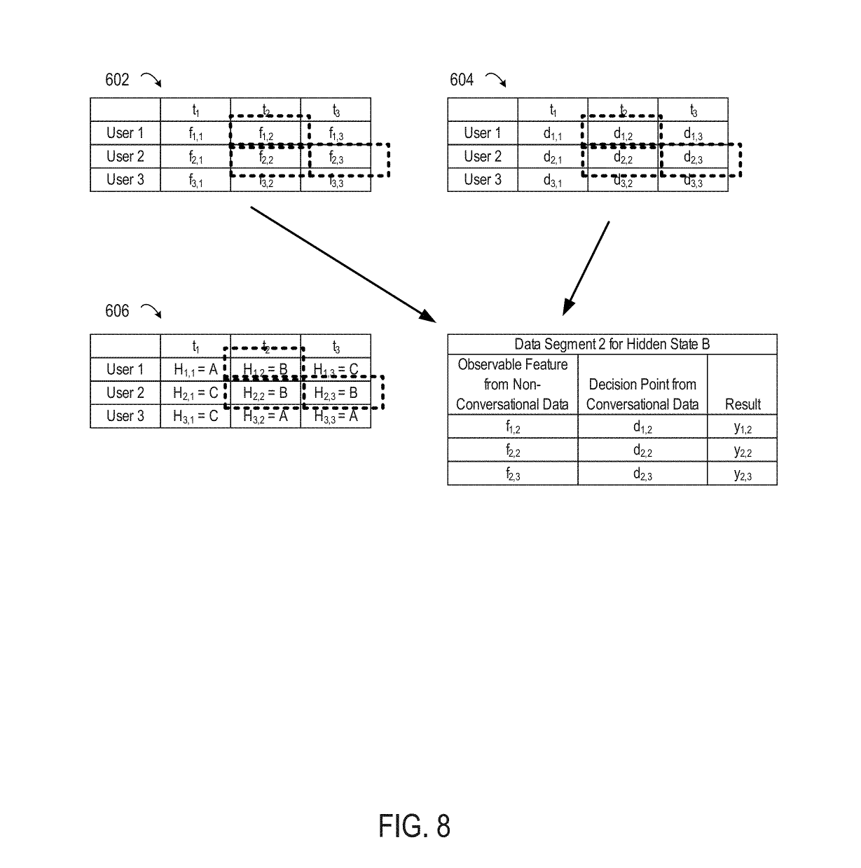

FIG. 8 depicts an example of segmenting the training data (i.e., the observations 602 and decision points 604) based on a second one of the hidden states 606. In this example, the training module 106 determines that User 1 was associated with the “B” hidden state at time t₂. Based on this determination, the training module 106 selects the corresponding observation f_{1,2} and decision point d_{1,2} for time t₂. Similarly, the training module 106 determines that User 2 was associated with the “B” hidden state at times t₂ and t₃, and therefore selects the corresponding observations and decision points for User 2 at times t₂ and t₃. The training module 106 assigns the selected observations and decision points to the data segment 2 that corresponds to the “B” hidden state. The training module 106 can train a logistic regression model or other predictive model for the “B” hidden state based on the data segment 2.

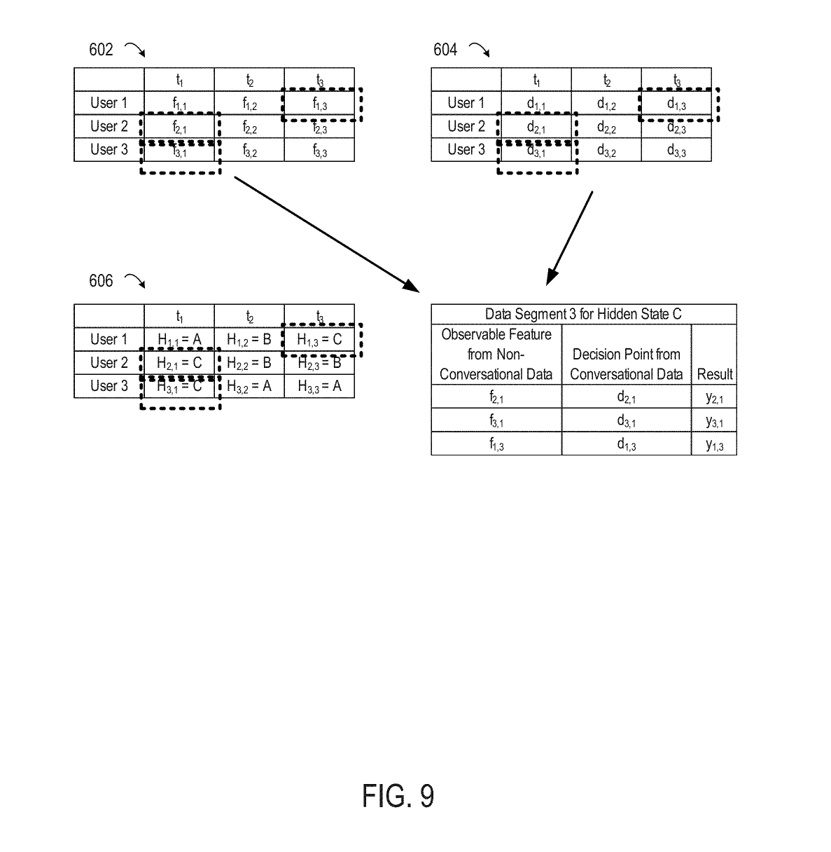

FIG. 9 depicts an example of segmenting the training data (i.e., the observations 602 and decision points 604) based on a third one of the hidden states 606. In this example, the training module 106 determines that User 1 was associated with the “C” hidden state at time t₃. Based on this determination, the training module 106 selects the corresponding observation f_{1,3} and decision point d_{1,3} for time t₃. Similarly, the training module 106 determines that User 2 and User 3 were associated with the “C” hidden state at time t₁, and therefore selects the corresponding observations and decision points for User 2 and User 3 at time t₁. The training module 106 assigns the selected observations and decision points to the data segment 3 that corresponds to the “C” hidden state. The training module 106 can train a logistic regression model or other predictive model for the “C” hidden state based on the data segment 3.

In some embodiments, models such as the consumer reaction models 222 generated in FIG. 4 enable the determination of value for prospective consumers and consumers for acquisition. The values may be determined even if little or no clickstream data is available from prospective consumers. Furthermore, deriving quantifiable features from conversation data captured in a relationship management tool 110 or other suitable application (e.g., email, social media services, etc.) can be used for detecting likely defectors and deploying proactive strategies to retain them. For example, if conversation data of a prospect or an existing consumer is analyzed using a consumer reaction model 222, the reaction probability can indicate a probability of conversion or defection. The probability of conversion or defection can be provided to the relationship management tool 110, which then recommends specific corrective actions with respect to that consumer (e.g., actions that may assist in acquiring the prospect as a consumer or retaining a current consumer).

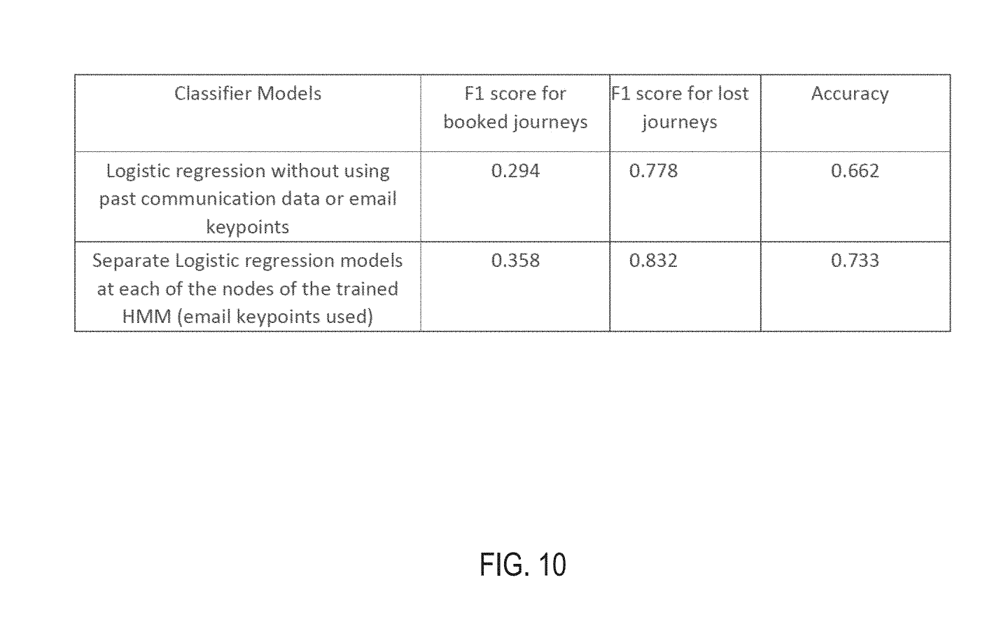

FIG. 10 depicts examples of comparisons between models developed using the processes described above and processes that do not involve conversational data. The evaluations depicted in FIG. 10 are obtained from a set of test data involving 326 journey records. The baseline for these comparisons is a logistic regression model that uses the current task features of a journey to predict if the journey will result in a conversion or a failure to obtain a conversion. The baseline is augmented using one or more of the operations described herein (e.g., using separate logistic regression models or other predict models at each of the nodes of the trained hidden Markov model). In some embodiments, these augmentations result in the improved performance depicted in FIG. 10 (e.g., F1 scores and accuracy).

Example of a Computing System for Providing a Consumer Reaction Model

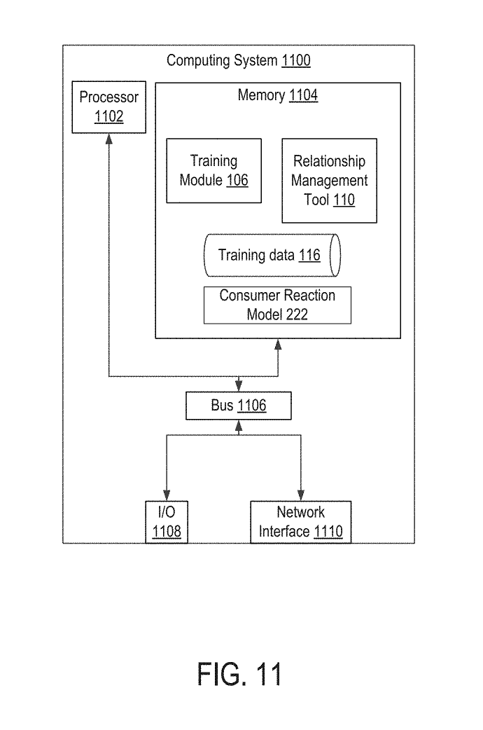

Any suitable computing system or group of computing systems can be used for performing the operations described herein. For example, FIG. 11 depicts examples of computing system 1100 that executes a training module 106. In some embodiments, the computing system 1100 also executes the relationship management tool 110, as depicted in FIG. 11. In other embodiments, a separate computing system having devices similar to those depicted in FIG. 11 (e.g., a processor, a memory, etc.) executes the relationship management tool 110.

The depicted examples of a computing system 1100 includes a processor 1102 communicatively coupled to one or more memory devices 1104. The processor 1102 executes computer-executable program code stored in a memory device 1104, accesses information stored in the memory device 1104, or both. Examples of the processor 1102 include a microprocessor, an application-specific integrated circuit (“ASIC”), a field-programmable gate array (“FPGA”), or any other suitable processing device. The processor 1102 can include any number of processing devices, including a single processing device.

The memory device 1104 includes any suitable non-transitory computer-readable medium for storing data, program code, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 1100 may also include a number of external or internal devices, such as input or output devices. For example, the computing system 1100 is shown with one or more input/output (“I/O”) interfaces 1108. An I/O interface 1108 can receive input from input devices or provide output to output devices. One or more buses 1106 are also included in the computing system 1100. The bus 1106 communicatively couples one or more components of a respective one of the computing system 1100.

The computing system 1100 executes program code that configures the processor 1102 to perform one or more of the operations described herein. The program code includes, for example, the training module 106, the relationship management tool 110, or other suitable applications that perform one or more operations described herein. The program code may be resident in the memory device 1104 or any suitable computer-readable medium and may be executed by the processor 1102 or any other suitable processor. In some embodiments, both the training module 106 and the relationship management tool 110 are stored in the memory device 1104, as depicted in FIG. 11. In additional or alternative embodiments, one or more of the training module 106 and the relationship management tool 110 are stored in different memory devices of different computing systems. In additional or alternative embodiments, the program code described above is stored in one or more other memory devices accessible via a data network.

The computing system 1100 can access one or more of the training data 116 and the trained consumer reaction model 222 in any suitable manner. In some embodiments, some or all of one or more of these data sets, models, and functions are stored in the memory device 1104, as in the example depicted in FIG. 11. For example, a computing system 1100 that executes the training module 106 can provide access to the trained consumer reaction model 222 by external systems that execute the relationship management tool 110.

In additional or alternative embodiments, one or more of these data sets, models, and functions are stored in the same memory device (e.g., one of the memory device 1104). For example, a common computing system, such as the marketing apparatus 104 depicted in FIG. 1, can host the training module 106 and the relationship management tool 110 as well as the trained consumer reaction model 222. In additional or alternative embodiments, one or more of the programs, data sets, models, and functions described herein are stored in one or more other memory devices accessible via a data network.

The computing system 1100 also includes a network interface device 1110. The network interface device 1110 includes any device or group of devices suitable for establishing a wired or wireless data connection to one or more data networks. Non-limiting examples of the network interface device 1110 include an Ethernet network adapter, a modem, and the like. The computing system 1100 is able to communicate with one or more other computing devices (e.g., a computing device executing a relationship management tool 110) via a data network using the network interface device 1110.

General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

1. A method comprising:
accessing, from a non-transitory computer-readable medium, training conversational data and training non-conversational data having observations;
identifying, by a processing device, decision points based on a textual analysis of the training conversational data;
generating, by the processing device, a hidden Markov model that is fitted to the training non-conversational data, wherein the hidden Markov model includes a first hidden state and a second hidden state;
grouping, by the processing device, the observations and decision points into data segments, wherein (i) a first data segment includes a first subset of the observations and the decision points associated with the first hidden state and (ii) a second data segment includes a second subset of the observations and the decision points associated with the second hidden state;
generating, by the processing device, a first predictive model for the first hidden state based on the first data segment and a second predictive model for the second hidden state based on the second data segment;
determining that input non-conversational data for an entity is more likely to correspond to the first hidden state as compared to the second hidden state; and
generating a predicted behavior by applying the first predictive model to input conversational data for the entity and the input non-conversational data.

2. The method of claim 1, wherein generating the hidden Markov model comprises:
selecting training sequences of observations from the training non-conversational data, wherein each observation includes one or more respective task features related to respective interactions with a respective consumer entity via a relationship management tool;
identifying a number of states for the hidden Markov model; and
fitting the training sequences of observations to a corresponding Markov chain having the identified number of states.

3. The method of claim 2, further comprising:
evaluating, based on a first output of a model-selection function, the hidden Markov model having the identified number of states, wherein the model-selection function includes a first term rewarding an increased log-likelihood for the hidden Markov model and a second term penalizing an increased number of states in the hidden Markov model;
identifying a different number of states for the hidden Markov model; and
fitting the training sequences of observations to an additional Markov chain having the different number of states;
evaluating, based on a second output of the model-selection function, the hidden Markov model having the different number of states; and
selecting the hidden Markov model having the different number of states based on the second output of the model-selection function being less than the first output of the model-selection function.

4. The method of claim 3, wherein the model-selection function comprises one or more of an Akaike Information Criterion function and a Bayesian Information Criterion function.

5. The method of claim 1, wherein grouping the observations and the decision points into the data segments comprises:
determining that the first hidden state is associated with a first subset of the observations associated that with a first time period;
identifying a first subset of the decision points associated with the first time period;
assigning the first subset of the observations and the first subset of the decision points to the first data segment based on the first time period being associated with the first hidden state, the first subset of the observations, and the first subset of the decision points;
determining that the second hidden state is associated with a second subset of the observations associated that with a second time period;
identifying a second subset of the decision points associated with the second time period; and
assigning the second subset of the observations and the second subset of the decision points to the second data segment based on the second time period being associated with the second hidden state, the second subset of the observations, and the second subset of the decision points.

6. The method of claim 1, wherein generating the first predictive model for the first hidden state and the second predictive model for the second hidden state comprises, for each hidden state of the first and second hidden states:
selecting a respective data segment is associated with the hidden state, wherein the respective data segment includes decision point values, observation values, and training predictive behavior values;
accessing a logistic regression model having (i) predictor variables corresponding to the decision point values and the observation values and (ii) an output variable corresponding to the training predictive behavior values;
determining a respective set of regression coefficients that combine the predictor variables having the decision point values and the observation values from the respective data segment into the training predictive behavior values; and
outputting the logistic regression model with the respective set of regression coefficients as a respective predictive model for the hidden state.

7. The method of claim 1, wherein generating the hidden Markov model comprises (i) selecting training sequences of observations from the training non-conversational data and (ii) fitting the training sequences of observations to a corresponding Markov chain, wherein the hidden Markov model generated from the training sequences of observations has a number of states that minimizes one or more of an Akaike Information Criterion function and a Bayesian Information Criterion function;
wherein grouping the observations and the decision points into the data segments comprises, for each hidden state:
determining that the hidden state is associated with a respective subset of the observations associated that with a respective time period,
identifying a respective subset of the decision points associated with the respective time period, and
grouping the respective subset of the observations and the respective subset of the decision points into a respective one of the data segments;
wherein generating the first predictive model for the first hidden state and the second predictive model for the second hidden state comprises, for each hidden state of the first and second hidden states:
selecting a respective data segment is associated with the hidden state, the data segment including decision point values, observation values, and training predictive behavior values,
accessing a logistic regression model having (i) predictor variables corresponding to the decision point values and the observation values and (ii) an output variable corresponding to the training predictive behavior values,
determining a respective set of regression coefficients that combine the predictor variables having the decision point values and the observation values from the respective data segment into the training predictive behavior values, and
outputting the logistic regression model with the respective set of regression coefficients as a respective predictive model for the hidden state.

8. A computing system comprising:
means for accessing training conversational data and training non-conversational data having observations;
means for identifying decision points based on a textual analysis of the training conversational data;
means for generating a hidden Markov model that is fitted to the training non-conversational data, wherein the hidden Markov model includes a first hidden state and a second hidden state;
means for grouping the observations and decision points into data segments, wherein (i) a first data segment includes a first subset of the observations and the decision points associated with the first hidden state and (ii) a second data segment includes a second subset of the observations and the decision points associated with the second hidden state;
means for generating a first predictive model for the first hidden state based on the first data segment and a second predictive model for the second hidden state based on the second data segment;
means for determining that input non-conversational data for an entity is more likely to correspond to the first hidden state as compared to the second hidden state; and
means for generating a predicted behavior by applying the first predictive model to input conversational data for the entity and the input non-conversational data.

9. The computing system of claim 8, wherein generating the hidden Markov model comprises:
selecting training sequences of observations from the training non-conversational data, wherein each observation includes one or more respective task features related to respective interactions with a respective consumer entity via a relationship management tool;
identifying a number of states for the hidden Markov model; and
fitting the training sequences of observations to a corresponding Markov chain having the identified number of states.

10. The computing system of claim 9, further comprising:
means for evaluating, based on a first output of a model-selection function, the hidden Markov model having the identified number of states, wherein the model-selection function includes a first term rewarding an increased log-likelihood for the hidden Markov model and a second term penalizing an increased number of states in the hidden Markov model;
means for identifying a different number of states for the hidden Markov model; and
means for fitting the training sequences of observations to an additional Markov chain having the different number of states;
means for evaluating, based on a second output of the model-selection function, the hidden Markov model having the different number of states; and
means for selecting the hidden Markov model having the different number of states based on the second output of the model-selection function being less than the first output of the model-selection function.

11. The computing system of claim 10, wherein the model-selection function comprises one or more of an Akaike Information Criterion function and a Bayesian Information Criterion function.

12. The computing system of claim 8, wherein grouping the observations and the decision points into the data segments comprises:
determining that the first hidden state is associated with a first subset of the observations associated that with a first time period;
identifying a first subset of the decision points associated with the first time period;
assigning the first subset of the observations and the first subset of the decision points to the first data segment based on the first time period being associated with the first hidden state, the first subset of the observations, and the first subset of the decision points;
determining that the second hidden state is associated with a second subset of the observations associated that with a second time period;
identifying a second subset of the decision points associated with the second time period; and
assigning the second subset of the observations and the second subset of the decision points to the second data segment based on the second time period being associated with the second hidden state, the second subset of the observations, and the second subset of the decision points.

13. The computing system of claim 8, wherein generating the first predictive model for the first hidden state and the second predictive model for the second hidden state comprises, for each hidden state of the first and second hidden states:
selecting a respective data segment is associated with the hidden state, wherein the respective data segment includes decision point values, observation values, and training predictive behavior values;
accessing a logistic regression model having (i) predictor variables corresponding to the decision point values and the observation values and (ii) an output variable corresponding to the training predictive behavior values;
determining a respective set of regression coefficients that combine the predictor variables having the decision point values and the observation values from the respective data segment into the training predictive behavior values; and
outputting the logistic regression model with the respective set of regression coefficients as a respective predictive model for the hidden state.

14. The computing system of claim 8, wherein generating the hidden Markov model comprises (i) selecting training sequences of observations from the training non-conversational data and (ii) fitting the training sequences of observations to a corresponding Markov chain, wherein the hidden Markov model generated from the training sequences of observations has a number of states that minimizes one or more of an Akaike Information Criterion function and a Bayesian Information Criterion function;
wherein grouping the observations and the decision points into the data segments comprises, for each hidden state:
determining that the hidden state is associated with a respective subset of the observations associated that with a respective time period,
identifying a respective subset of the decision points associated with the respective time period, and
grouping the respective subset of the observations and the respective subset of the decision points into a respective one of the data segments;
wherein generating the first predictive model for the first hidden state and the second predictive model for the second hidden state comprises, for each hidden state of the first and second hidden states:
selecting a respective data segment is associated with the hidden state, the data segment including decision point values, observation values, and training predictive behavior values,
accessing a logistic regression model having (i) predictor variables corresponding to the decision point values and the observation values and (ii) an output variable corresponding to the training predictive behavior values,
determining a respective set of regression coefficients that combine the predictor variables having the decision point values and the observation values from the respective data segment into the training predictive behavior values, and
outputting the logistic regression model with the respective set of regression coefficients as a respective predictive model for the hidden state.

15. A non-transitory computer-readable medium having instructions stored thereon, the instructions executable by a processing device to perform operations comprising:
accessing training conversational data and training non-conversational data having observations;
identifying decision points based on a textual analysis of the training conversational data;
generating a hidden Markov model that is fitted to the training non-conversational data, wherein the hidden Markov model includes a first hidden state and a second hidden state;
grouping the observations and decision points into data segments, wherein (i) a first data segment includes a first subset of the observations and the decision points associated with the first hidden state and (ii) a second data segment includes a second subset of the observations and the decision points associated with the second hidden state;
generating a first predictive model for the first hidden state based on the first data segment and a second predictive model for the second hidden state based on the second data segment;
determining that input non-conversational data for an entity is more likely to correspond to the first hidden state as compared to the second hidden state; and
generating a predicted behavior by applying the first predictive model to input conversational data for the entity and the input non-conversational data.

16. The non-transitory computer-readable medium of claim 15, wherein generating the hidden Markov model comprises:
selecting training sequences of observations from the training non-conversational data, wherein each observation includes one or more respective task features related to respective interactions with a respective consumer entity via a relationship management tool;
identifying a number of states for the hidden Markov model; and
fitting the training sequences of observations to a corresponding Markov chain having the identified number of states.

17. The non-transitory computer-readable medium of claim 16, the operations further comprising:
evaluating, based on a first output of a model-selection function, the hidden Markov model having the identified number of states, wherein the model-selection function includes a first term rewarding an increased log-likelihood for the hidden Markov model and a second term penalizing an increased number of states in the hidden Markov model;
identifying a different number of states for the hidden Markov model; and
fitting the training sequences of observations to an additional Markov chain having the different number of states;
evaluating, based on a second output of the model-selection function, the hidden Markov model having the different number of states; and
selecting the hidden Markov model having the different number of states based on the second output of the model-selection function being less than the first output of the model-selection function.

18. The non-transitory computer-readable medium of claim 15, wherein grouping the observations and the decision points into the data segments comprises:
determining that the first hidden state is associated with a first subset of the observations associated that with a first time period;
identifying a first subset of the decision points associated with the first time period;
assigning the first subset of the observations and the first subset of the decision points to the first data segment based on the first time period being associated with the first hidden state, the first subset of the observations, and the first subset of the decision points;
determining that the second hidden state is associated with a second subset of the observations associated that with a second time period;
identifying a second subset of the decision points associated with the second time period; and
assigning the second subset of the observations and the second subset of the decision points to the second data segment based on the second time period being associated with the second hidden state, the second subset of the observations, and the second subset of the decision points.

19. The non-transitory computer-readable medium of claim 15, wherein generating the first predictive model for the first hidden state and the second predictive model for the second hidden state comprises, for each hidden state of the first and second hidden states:
selecting a respective data segment is associated with the hidden state, wherein the respective data segment includes decision point values, observation values, and training predictive behavior values;
accessing a logistic regression model having (i) predictor variables corresponding to the decision point values and the observation values and (ii) an output variable corresponding to the training predictive behavior values;
determining a respective set of regression coefficients that combine the predictor variables having the decision point values and the observation values from the respective data segment into the training predictive behavior values; and
outputting the logistic regression model with the respective set of regression coefficients as a respective predictive model for the hidden state.

20. The non-transitory computer-readable medium of claim 15, wherein generating the hidden Markov model comprises (i) selecting training sequences of observations from the training non-conversational data and (ii) fitting the training sequences of observations to a corresponding Markov chain, wherein the hidden Markov model generated from the training sequences of observations has a number of states that minimizes one or more of an Akaike Information Criterion function and a Bayesian Information Criterion function;
wherein grouping the observations and the decision points into the data segments comprises, for each hidden state:
determining that the hidden state is associated with a respective subset of the observations associated that with a respective time period,
identifying a respective subset of the decision points associated with the respective time period, and
grouping the respective subset of the observations and the respective subset of the decision points into a respective one of the data segments;
wherein generating the first predictive model for the first hidden state and the second predictive model for the second hidden state comprises, for each hidden state of the first and second hidden states:
selecting a respective data segment is associated with the hidden state, the data segment including decision point values, observation values, and training predictive behavior values,
accessing a logistic regression model having (i) predictor variables corresponding to the decision point values and the observation values and (ii) an output variable corresponding to the training predictive behavior values,
determining a respective set of regression coefficients that combine the predictor variables having the decision point values and the observation values from the respective data segment into the training predictive behavior values, and
outputting the logistic regression model with the respective set of regression coefficients as a respective predictive model for the hidden state.
